(19) United States
(12) Patent Application Publication
(10) Pub. No.: US 2025/0385239 A1
(43) Pub. Date: Dec. 18, 2025

(54) SECONDARY BATTERY AND PREPARATION METHOD THEREOF

(71) Applicant: BATTEROTECH CORPORATION LIMITED, Shanghai (CN)

(72) Inventors: Ruili REN, Shanghai (CN); Wenjia CHEN, Shanghai (CN); Yaping ZHANG, Shanghai (CN)

(73) Assignee: BATTEROTECH CORPORATION LIMITED, Shanghai (CN)

(21) Appl. No.: 19/320,589

(22) Filed: Sep. 5, 2025

Related U.S. Application Data
(63) Continuation of application No. PCT/CN2023/124298, filed on Oct. 12, 2023.

(30) Foreign Application Priority Data
Mar. 7, 2023 (CN) 202310214621.9

(51) Int. Cl. H01M 4/04; H01M 4/1393; H01M 4/587; H01M 4/62

(52) U.S. Cl. CPC H01M 4/0404; H01M 4/0435; H01M 4/1393; H01M 4/587; H01M 4/622; H01M 4/625

(57) ABSTRACT

Disclosed are a secondary battery and a preparation method thereof, including a preparation method for a negative electrode plate, the preparation method for the negative electrode plate includes: mixing a negative electrode active material, a conductive agent, and a binder uniformly in a solvent to form a slurry for a negative electrode active material layer; coating the slurry for the negative electrode active material layer on at least one surface of a negative electrode current collector to obtain a negative electrode plate to be calendered, which includes a negative electrode film formed by the slurry for the negative electrode active material layer; after calendering, forming the negative electrode plate, manufacturing a test cell using the negative electrode plate; manufacturing the secondary battery by combining the negative electrode plate, a positive electrode plate, a separator and an electrolyte solution; the secondary battery satisfies a relational formula: 0.9≤U×(1+r)/(ρ+7.4)/d/(1+5.3×ln(t))/1.335≤1.1.

### CROSS REFERENCE TO RELATED APPLICATION(S)

This disclosure is a continuation under 35 U.S.C. § 111 of international application number PCT/CN2023/124298, filed on Oct. 12, 2023, which claims the benefit of priority of Chinese patent application No. 202310214621.9, filed on Mar. 7, 2023, the entire contents of which are incorporated herein by reference.

### TECHNICAL FIELD

Embodiments of the present disclosure relate to the technical field of batteries, such as a secondary battery and a preparation method thereof.

### BACKGROUND

Lithium-ion batteries are widely used in fields such as electric vehicles, consumer electronics, and energy storage due to their high energy density, long cycle life, no memory effect, environmental friendliness, and other advantages. Especially, in the field of electric vehicles, the installed capacity of lithium-ion batteries has rapidly increased in recent years. At present, the range of commercially available electric vehicles can reach 500 km, which is close to the level of fuel vehicles. However, the energy replenishment speed of electric vehicles is lower, and a fast charging technology provided in the prior art can only achieve a speed of charging 60% of the battery in 30 minutes. Therefore, further increasing the charging speed of batteries and reducing the charging time of batteries have become one of the key factors for alleviating range anxiety and improving competitiveness of electric vehicles.

In a charging process of batteries, lithium ions are deintercalated from a positive electrode material and intercalated into a negative electrode material via an electrolyte. At present, commercially available negative electrode materials mainly include graphite materials, but graphite materials have a relatively low lithium intercalation potential, which is only 80 mV. When the charging speed of batteries increases, a charging current increases may cause polarization of the potential of a negative electrode. When the lithium potential decreases to 0 m V, a risk of lithium ions being reduced to metallic lithium is increased. When lithium precipitates on a surface of a negative electrode, the capacity of batteries may also decrease. Moreover, lithium metal may form lithium dendrites that pierce through a separator, causing short circuits in batteries, and resulting in losing effectiveness, and even fire and explosion of the batteries. Therefore, the design of a negative electrode structure is one of the key technologies for achieving fast charging of lithium-ion batteries.

In recent years, negative electrode materials used in fast charging battery systems are mainly implemented by optimizing material structures and reducing surface densities. However, the finer the fast charging performance of the negative electrode materials, the lower the corresponding gram capacity. The lower the surface densities of the negative electrode materials, the lower the mass proportion of active materials in battery cells, leading to lower energy densities of batteries.

Therefore, in this field, there is an urgent need to develop a negative electrode material that not only has good fast charging capability, but also has high energy density and high specific capacity.

### SUMMARY

Embodiments of the present disclosure provide a secondary battery and a preparation method thereof. The present disclosure obtains a lithium-ion battery with both fast charging capability and high energy density by optimizing a structure of a negative electrode of a lithium-ion battery.

According to a first aspect, an embodiment of the present application provides a preparation method for a secondary battery, including a preparation method for a negative electrode plate, the preparation method for the negative electrode plate includes:
mixing a negative electrode active material, a conductive agent, and a binder uniformly in a solvent to form a slurry for a negative electrode active material layer;
coating the slurry for the negative electrode active material layer on at least one surface of a negative electrode current collector to obtain a negative electrode plate to be calendered, which comprises a negative electrode film formed by the slurry for the negative electrode active material layer, wherein d represents a surface density of the negative electrode film, a value range of the d is 30-200 g/m²;
after calendering, forming the negative electrode plate, wherein a density of the negative electrode film after calendering is ρ, a range of ρ is 1 g/cm³-2 g/cm³;
manufacturing a test cell using the negative electrode plate, obtaining a ratio of increase r in thickness of the negative electrode film after the test cell is fully charged, a value range of the r is

$$0.1 \% \leq r \leq 20 \% ;$$

according to the test cell, an average voltage with a capacity of 20-90% is taken as a voltage of a lithium intercalation plate U, a value range of the U is 5 mV-1500 mV;
the preparation method further includes:
manufacturing the secondary battery by combining the negative electrode plate, a positive electrode plate, a separator, and an electrolyte solution;
the secondary battery satisfies a relational formula:

$$0.9 \leq U \times ( 1 + r ) / ( ρ + 7.4 ) / d / ( 1 + 5.3 \times ln ( t ) ) / 1.335 \leq 1.1 ,$$

wherein t represents a charging time of the secondary battery from 10% state of charge (SOC) to 80% SOC in min, a value range of the t is 5-100 min.

In the present disclosure, the secondary battery is designed to satisfy the following relational formula: 0.9≤U×(1+r)/(ρ+7.4)/d/(1+5.3×ln(t))/1.335≤1.1. By reasonably configuring the lithium intercalation plateau voltage U, the ratio of increase in thickness of the negative electrode film, the density of the negative electrode film, the surface density of the negative electrode film, and the charging time of the secondary battery from 10% SOC to 80% SOC, the physical and chemical parameters satisfy a specific relationship, and the prepared battery not only has fine fast charging performance, but also has an improved energy density.

In a charging process of batteries, the negative electrode plate needs to go through the following three electrochemical processes: (1) ions (e.g., lithium ions or sodium ions) deintercalated from a positive electrode active material enter an electrolyte and, along with the electrolyte, enter pores of a negative porous electrode, for liquid-phase conduction in the pores; (2) the ions exchange charges with electrons on the surface of a negative electrode active material; and (3) the ions are subjected to solid-phase conduction from the surface of the negative electrode active material into the bulk phase of the negative electrode active material.

The liquid-phase conduction of the ions in the pores of the negative porous electrode has a crucial impact on improving the fast charging capability of batteries, and the liquid-phase conduction of the ions in the pores of the negative porous electrode is closely related to the structural morphology of the pores in the negative electrode film.

Preferably, the secondary battery satisfies a relational formula:

$$0.95 \leq U \times ( 1 + r ) / ( ρ + 7.4 ) / d / ( 1 + 5.3 \times ln ( t ) ) / 1.335 \leq 1.05 .$$

In the negative electrode plate of the present disclosure, parameters of the negative electrode plate may be tested as follows:

The r is the ratio of increase in thickness of the negative electrode film after full charge, and is tested as follows: the thickness of the negative electrode plate to be calendered after calendering is L₁, the thickness of a negative electrode current collector is L₀, the battery cell is charged at a constant current of 1 C to the upper limit of voltage and charged at a constant voltage to 0.05 C, and after the battery cell is disassembled, the thickness of the negative electrode plate is L₂, r=(L₂−L₀)/(L₁−L₀).

The d is the surface density of the negative electrode film, and is tested as follows: the negative electrode plate to be calendered is obtained after the negative electrode current collector is coated on both sides, a negative electrode plate to be calendered with an area of 100 cm² is taken, the mass of the negative electrode plate is measured as W₁, and the mass of the 100 cm² current collector for coating is measured as W₂, d=100×(W₁−W₂).

The ρ is the density of the negative electrode film, and is tested as follows: the negative electrode plate is formed after calendering, the thickness of the electrode plate is measured,

$$ρ = 2 \times d / ( {L}_{1} - {L}_{0} ) .$$

Preferably, the binder includes any one or a combination of at least two of polybutadiene styrene compounds, polyphenylene propylene compounds, polyvinylidene fluoride compounds, and polyacrylic compounds.

### DETAILED DESCRIPTION OF THE EMBODIMENTS

The technical solution of the present disclosure will be further described with specific implementations. Those skilled in the art should understand that the embodiments described are only intended to help understand the present disclosure and should not be regarded as specific limitations on the present disclosure.

Lithium-ion batteries provided in Embodiments 1 to 10 and Comparative Examples 1 to 6 were prepared by the following method.

### 1, Preparation of Positive Electrode Plate

92 wt. % of an LiNi_{0.6}Mn_{0.2}Co_{0.2}O₂ positive electrode active material, 5 wt. % of a conductive agent Super-P, and 3 wt. % of a polyvinylidene fluoride binder were mixed uniformly in N-methylpyrrolidone as a solvent to prepare slurry of a positive electrode active material layer. The slurry of the positive electrode active material layer was applied onto both sides of an aluminum foil having a thickness of 13 μm by extrusion coating, and dried at 85° C. to obtain the positive electrode active material layer. Then, the aluminum foil current collector was cold pressed and cut, dried under vacuum at 85° C. for 4 h, and welded with tabs to obtain the positive electrode plate.

### 2, Preparation of Negative Electrode Plate

A negative electrode active material artificial graphite, a conductive agent Super-P, a thickener sodium carboxymethyl cellulose, and a styrene butadiene latex binder in a mass ratio of 96.5:1.0:1.0:1.5 were added to deionized water and mixed uniformly to prepare slurry of a negative electrode active material layer. The slurry of the negative electrode active material layer was applied onto both sides of a copper foil having a thickness of 6 μm by extrusion coating, and dried at 85° C. to obtain the negative electrode active material layer. The negative electrode plate was obtained after post-treatment.

(1) A negative electrode active material, the conductive agent, the binder in a mass ratio were added to a solvent (deionized water) and mixed uniformly to prepare the slurry of the negative electrode active material layer.

In the present disclosure, the average particle size of the negative electrode active material is 5 μm-12 μm. Adjusting the average particle size of the negative electrode active material in an appropriate range is favorable for promoting diffusion of ions in the negative electrode active material.

In some embodiments, the negative electrode active material includes any one or a combination of at least two of a combination of graphite and a carbon material, graphite, a silicon material, and lithium titanate. In some embodiments, the mass percentage of graphite in the negative electrode active material is 70-100%, for example, 70%, 75%, 80%, 85%, 90%, 95%, and 100%.

In some embodiments, the mass percentage of the conductive agent in the negative electrode film is 0.3%-10%, for example, 0.3%, 0.5%, 1%, 2%, 5%, 8%, and 10%.

Preferably, the mass percentage of the binder in the negative electrode film is 0.3%-10%, for example, 0.3%, 0.5%, 1%, 2%, 5%, 8%, and 10%.

In the present disclosure, by adjusting the content of the conductive agent, the binder, and the negative electrode active material in the negative electrode film, the secondary battery assembled from the prepared negative electrode plate has high energy density and favorable fast charging capability.

(2) Using an extrusion coating method, the negative electrode active material layer slurry is coated on both sides of the copper foil (negative electrode current collector). The negative electrode plate includes the negative electrode current collector and a negative electrode film layer disposed on at least one surface of the negative electrode current collector. The negative electrode film layer includes the negative electrode active material, the conductive agent, and a binder.

The applicant has found through extensive research that the fast charging capability and energy improvement of batteries are closely related to the lithium intercalation plateau voltage U, the ratio r of increase in thickness of the negative electrode film after full charge, the density ρ of the negative electrode film, and the surface density d of the negative electrode film. The larger the U, the more favorable for fast charging, but a decrease in energy density is caused. The larger the r value, the more favorable for fast charging, but a decrease in energy density may be caused. The larger the p, the more favorable for energy density improvement, but the fast charging capability may be lower. The larger the d value, the more favorable for energy density improvement, but the fast charging capability may be lower. Therefore, the numerical ranges of the parameters need to be reasonably regulated.

The negative electrode plate to be calendered is obtained after the negative electrode current collector is coated on both sides, a negative electrode plate to be calendered with an area of 100 cm² is taken, the mass of the negative electrode plate to be calendered is measured as W₁, and the mass of the 100 cm² current collector for coating is measured as W₂, d=100×(W₁−W₂), d represents a surface density of the negative electrode film in g/m².

In some embodiments, a value range of the d is 30-200 g/m², preferably 50-180 g/m², for example, 30 g/m², 40 g/m², 60 g/m², 80 g/m², 100 g/m², 120 g/m², 150 g/m², 180 g/m², and 200 g/m².

In the present disclosure, an excessively low or high value range of the d may cause a decrease in the energy density or charging speed of the battery.

After calendering, the negative electrode plate is prepared and its thickness is measured, the thickness of the negative electrode plate after calendering is L₁, the thickness of a negative electrode current collector is L₀, the density of the negative electrode film satisfies the following formula: ρ=2×d/(L₁−L₀). Wherein, the ρ represents the density of the negative electrode film in g/cm³.

In some embodiments, a value range of the ρ is 1 g/cm³-2 g/cm³, preferably 1.2 g/cm³-1.85 g/cm³, for example, 1 g/cm³, 1.2 g/cm³, 1.5 g/cm³, 1.85 g/cm³, and 2 g/cm³.

In the present disclosure, an excessively low or high value range of the ρ may cause a decrease in the energy density or charging speed of the battery.

### (3) Drying and Post-Processing to Obtain the Negative Electrode Plate

The test cells were prepared by the negative electrode plates.

The test cell is charged at a constant current of 1 C to the upper limit of voltage and charged at a constant voltage to 0.05 C, and after the test cell is disassembled, the thickness of the negative electrode plate is L₂, r=(L₂−L₀)/(L₁−L₀), the r is the ratio of increase in thickness of the negative electrode film after full charge.

In some embodiments, a value range of the r is 0.1%≤r≤20%, preferably 0.1%-0.3%, for example, 0.1%, 0.12%, 0.15%, 0.18%, 0.2%, 0.22%, 0.25%, 0.28%, 0.3%, 1%, 5%, 8%, 10%, 12%, 15%, 18%, and 20%.

In the present disclosure, an excessively low or high value range of the r may cause a decrease in the charging speed or energy density of the battery.

The U represents the voltage of the lithium intercalation plate in mV.

The U represents an average voltage with a capacity of 20-90% of the test cell charged to 5 mV at a constant current under a rate of 0.1 C, then charged to 50 mA at a constant voltage, and finally charged to 2.0 V at a constant current.

In some embodiments, a value range of the U is 5-1500 mV, preferably 10-1000 mV, for example, 5 mV, 10 mV, 20 mV, 50 mV, 80 mV, 100 mV, 200 mV, 500 mV, 800 mV, 1000 mV, 1200 mV, and 1500 mV.

In the present disclosure, an excessively low or high value range of the U may cause a decrease in the charging speed or energy density of the battery.

### 3, Preparation of Lithium-Ion Battery

The positive electrode plate (having a compacted density of 3.4 g/cm³), a PP/PE/PP multilayer separator, and the negative electrode plate were wrapped into a bare battery cell, and the bare battery cell was placed in a battery case. An electrolyte (where a non-aqueous solvent consisted of ethylene carbonate and methyl ethyl carbonate in a volume ratio of 3:7, and the concentration of LiPF₆ was 1 mol/L) was injected, followed by sealing, formation and other processes. Finally, a lithium-ion battery with a capacity of 50 Ah was obtained.

Wherein, t represents a charging time of the secondary battery from 10% SOC to 80% SOC in min; a value range of the tis 5-100 min, for example, 5 min, 8 min, 10 min, 20 min, 50 min, 80 min, and 100 min.

In the present disclosure, an excessively low or high value range of the t may cause lithium precipitation, causing safety hazards or low charging speed of the battery.

By controlling the increase ratio in thickness of the negative electrode film, the density of the negative electrode film, the surface density of the negative electrode film, as well as reasonably configuring the lithium intercalation plateau voltage U, and controlling the charging time t of the secondary battery from 10% State of Charge (SOC) to 80% SOC, the physical and chemical parameters satisfy a specific relationship, 0.9≤U×(1+r)/(ρ+7.4)/d/(1+5.3×ln(t))/1.335≤1.1, and the prepared battery not only has fine fast charging performance, but also has an improved energy density.

Specific parameters of the lithium-ion batteries are shown in Table 1:

TABLE 1

| | | U | | d | ρ | t |
|---|---|---|---|---|---|---|
| | S | (mV) | r | (g/m²) | (g/cm³) | (min) |
| Embodiment 1 | 0.922 | 60 | 0.1 | 100 | 1.65 | 20 |
| Embodiment 2 | 0.915 | 60 | 0.3 | 100 | 1.65 | 12 |
| Embodiment 3 | 0.963 | 60 | 0.2 | 100 | 1.2 | 15 |
| Embodiment 4 | 0.989 | 60 | 0.2 | 100 | 1.8 | 20 |
| Embodiment 5 | 0.912 | 60 | 0.2 | 180 | 1.65 | 150 |
| Embodiment 6 | 0.947 | 60 | 0.2 | 50 | 1.65 | 10 |
| Embodiment 7 | 1.039 | 60 | 0.1 | 100 | 1.65 | 30 |
| Embodiment 8 | 0.991 | 60 | 0.3 | 100 | 1.65 | 15 |
| Embodiment 9 | 0.920 | 60 | 0.2 | 90 | 1.2 | 10 |
| Embodiment 10 | 1.083 | 60 | 0.2 | 100 | 1.8 | 27 |
| Comparative | 3.632 | 60 | 0.3 | 30 | 1.65 | 20 |
| Example 1 | | | | | | |
| Comparative | 0.890 | 60 | 0.3 | 200 | 1.65 | 150 |
| Example 2 | | | | | | |
| Comparative | 0.895 | 60 | 0.3 | 100 | 1.85 | 12 |
| Example 3 | | | | | | |
| Comparative | 1.133 | 60 | 0.3 | 100 | 1.3 | 20 |
| Example 4 | | | | | | |
| Comparative | 1.118 | 60 | 0.2 | 90 | 1.65 | 20 |
| Example 5 | | | | | | |
| Comparative | 0.881 | 60 | 0.2 | 105 | 1.55 | 15 |
| Example 6 | | | | | | |

### Test Condition

The lithium-ion batteries provided in Embodiments 1 to 10 and Comparative Examples 1 to 6 were tested by the following methods:

At a charging rate C=1/t×60, the lithium-ion batteries were charged at a constant current at the C to the upper limit of voltage, charged at a constant current to 0.05 C, and allowed to stand for 30 min. The energy of the battery cell was obtained as W, and the mass m of the battery cell was weighed using a balance, the energy density of the battery cell: ED=W/m.

At a charging rate C=1/t×60, the lithium-ion batteries were charged at a constant current at the C to the upper limit of voltage, charged at a constant current to 0.05 C, allowed to stand for 30 min, discharged at 1 C, and allowed to stand for 30 min. After repetition for 10 times, the battery cells were disassembled and checked for lithium precipitation of the negative electrode plates.

Test results are shown in Table 2:

TABLE 2

| | Energy density | |
|---|---|---|
| | (Wh/kg) | Lithium precipitation |
| Embodiment 1 | 230 | No lithium precipitated |
| Embodiment 2 | 228 | No lithium precipitated |
| Embodiment 3 | 233 | No lithium precipitated |
| Embodiment 4 | 230 | No lithium precipitated |
| Embodiment 5 | 229 | No lithium precipitated |
| Embodiment 6 | 225 | No lithium precipitated |
| Embodiment 7 | 229 | No lithium precipitated |
| Embodiment 8 | 229 | No lithium precipitated |
| Embodiment 9 | 229 | No lithium precipitated |
| Embodiment 10 | 229 | No lithium precipitated |
| Comparative Example 1 | 202 | No lithium precipitated |
| Comparative Example 2 | 223 | Lithium precipitated |
| Comparative Example 3 | 222 | Lithium precipitated |
| Comparative Example 4 | 210 | No lithium precipitated |
| Comparative Example 5 | 212 | No lithium precipitated |
| Comparative Example 6 | 225 | Lithium precipitated |

From Table 1, Comparative Examples 1, 4, and 5 indicate that when U×(1+r)/(ρ+7.4)/d/(1+5.3×ln(t))/1.335>1.1, the energy density of the battery cells is lower than that of the battery cells in the preferred range; and Comparative Examples 2, 3, and 6 indicate that when U×(1+r)/(ρ+7.4)/d/(1+5.3×ln (t))/1.335<0.9, lithium is more likely to precipitate when the charging time of the energy of the battery cells is same, and the fast charging performance also decreases.

In the present disclosure, the secondary battery is designed to satisfy the following relational formula: 0.9≤U×(1+r)/(ρ+7.4)/d/(1+5.3×ln(t))/1.335≤1.1. By reasonably configuring the lithium intercalation plateau, the ratio of increase in thickness of the negative electrode film, the density of the negative electrode film, the surface density of the negative electrode film, and the charging time of the secondary battery from 10% SOC to 80% SOC, the physical and chemical parameters satisfy a specific relationship, and the prepared battery not only has fine fast charging performance, but also has an improved energy density.

The applicant declares that the technological method of the present disclosure is described with the above embodiments, but the present disclosure is not limited to the above process steps, i.e., it does not mean that the present disclosure must be implemented by the above process steps. Those skilled in the art should understand that any improvements made to the present disclosure, equivalent substitutions of raw materials used in the present disclosure, addition of auxiliary components, and selection of specific methods are within the scopes of protection and disclosure of the present disclosure.

1. A preparation method for a secondary battery, comprising a preparation method for a negative electrode plate, the preparation method for the negative electrode plate comprises:
mixing a negative electrode active material, a conductive agent, and a binder uniformly in a solvent to form a slurry for a negative electrode active material layer;
coating the slurry for the negative electrode active material layer on at least one surface of a negative electrode current collector to obtain a negative electrode plate to be calendered, which comprises a negative electrode film formed by the slurry for the negative electrode active material layer, wherein d represents a surface density of the negative electrode film, a value range of the d is 30 g/m²-200 g/m²;
after calendering, forming the negative electrode plate, wherein a density of the negative electrode film after calendering is ρ, a range of ρ is 1 g/cm³-2 g/cm³;
manufacturing a test cell using the negative electrode plate, obtaining a ratio of increase r in thickness of the negative electrode film after the test cell is fully charged, a value range of the r is 0.1%≤r≤20%;
according to the test cell, an average voltage with a capacity of 20-90% is taken as a voltage of a lithium intercalation plate U, a value range of the U is 5 mV-1500 mV;
the preparation method further comprises:
manufacturing the secondary battery by combining the negative electrode plate, a positive electrode plate, a separator, and an electrolyte solution;
the secondary battery satisfies a relational formula:
$$0.9 \leq U \times ( 1 + r ) / ( ρ + 7.4 ) / d / ( 1 + 5.3 \times ln ( t ) ) / 1.335 \leq 1.1 ,$$
wherein t represents a charging time of the secondary battery from 10% state of charge (SOC) to 80% SOC in min, a value range of the tis 5-100 min.

2. The preparation method for the secondary battery according to claim 1, wherein d represents a difference between a mass per unit area of a current collector used for coating (W₂) and a mass of the electrode negative electrode plate (W₁).

3. The preparation method for the secondary battery according to claim 2, wherein ρ satisfies a following formula:
ρ=2×d/(L₁−L₀), wherein L₁ represents a thickness of the negative electrode plate after calendering, while L₀ represents a thickness of the negative current collector.

4. The preparation method for the secondary battery according to claim 3, wherein a step of obtaining the ratio of increase r in thickness of the negative electrode film after the test cell is fully charged comprises: the test cell is charged at a constant current of 1 C to an upper limit of voltage and charged at a constant voltage to 0.05 C, and obtain the ratio of increase r in thickness of the negative electrode film after the test cell is fully charged, wherein the r satisfies a following formula: r=(L₂−L₀)/(L₁−L₀), L₂ represents a thickness of the negative electrode plate after being fully charged.

5. The preparation method of the secondary battery according to claim 1, wherein the average voltage with a capacity of 20%-90% is taken as the voltage of the lithium intercalation plate U comprises: the voltage of the lithium intercalation plate U represents an average voltage with a capacity of 20-90% of the test cell charged to 5 mV at a constant current under a rate of 0.1 C, then charged to 50 mA at a constant voltage, and finally charged to 2.0 V at a constant current.

6. The preparation method for the secondary battery according to claim 2, wherein a value of the d is 30 g/m², 40 g/m², 60 g/m², 80 g/m², 100 g/m², 120 g/m², 150 g/m², 180 g/m², or 200 g/m².

7. The preparation method for the secondary battery according to claim 3, wherein a value of the ρ is 1 g/cm³, 1.2 g/cm³, 1.5 g/cm³, 1.85 g/cm³, or 2 g/cm³.

8. The preparation method for the secondary battery according to claim 4, wherein a value of the r is 0.1%, 0.12%, 0.15%, 0.18%, 0.2%, 0.22%, 0.25%, 0.28%, 0.3%, 1%, 5%, 8%, 10%, 12%, 15%, 18%, or 20%.

9. The preparation method for the secondary battery according to claim 5, wherein a value of the U is 5 mV, 10 mV, 20 mV, 50 mV, 80 mV, 100 mV, 200 mV, 500 mV, 800 mV, 1000 mV, 1200 mV, or 1500 mV.

10. The preparation method for the secondary battery according to claim 1, wherein a value of the t is 5 min, 8 min, 10 min, 20 min, 50 min, 80 min, or 100 min.

11. The preparation method for the secondary battery according to claim 1, wherein the negative electrode active material comprises any one or a combination of at least two of a combination of graphite and a carbon material, graphite, a silicon material, and lithium titanate; an average particle size of the negative electrode active material is 5 μm-12 μm.

12. The preparation method for the secondary battery according to claim 11, wherein a mass percentage of graphite in the negative electrode active material is 70%-100%.

13. The preparation method for the secondary battery according to claim 1, wherein the conductive agent comprises carbon nanotubes and/or carbon black, a mass percentage of the conductive agent is 0.3%-10%.

14. The preparation method for the secondary battery according to claim 1, wherein the binder comprises any one or a combination of at least two of polybutadiene styrene compounds, polyphenylene propylene compounds, polyvinylidene fluoride compounds, and polyacrylic compounds; a mass percentage of the binder is 0.3%-10%.

15. A secondary battery, prepared by the preparation method according to claim 1.
